(19) United States
(12) Patent Application Publication
(10) Pub. No.: US 2008/0119985 A1
(43) Pub. Date: May 22, 2008

(54) CONTROLLER SENSE INVERTER FOR POWERED VEHICLES HAVING A ROTATING TURRET

(76) Inventor: Edward D. Schubitzke, Saginaw, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/929,386

(22) Filed: Oct. 30, 2007

Related U.S. Application Data
(60) Provisional application No. 60/855,230, filed on Oct. 30, 2006.

(51) Int. Cl. B62D 6/00

(52) U.S. Cl. 701/41

(57) ABSTRACT

A rotating turret vehicle having steering controls in the turret, has the sense of those controls reversed when the turret faces to the rear of the vehicle. Thus, when the operator faces the rear of the vehicle due to turret rotation, the sense of the controls are reversed so he or she operates the controls as when facing forward. Pushing a lever forward to cause forward vehicle movement when facing forward, causes reverse movement when facing backward.

### FIELD OF THE INVENTION

The invention pertains to the controls for a type of powered vehicle. The vehicle type involved has a turret mounted on an upper surface of a carrier having tracks or wheels allowing controlled movement of the carrier along the ground. An operator for the vehicle sits in the turret. The carrier supports the turret for rotation on a circular track or a heavy stub shaft. Rotation is about an axis that is vertical relative to the carrier.

Some types of construction equipment such as excavators and perhaps army tanks as well, have this construction. The term used for these types of vehicles hereafter is “rotating turret vehicles” or RTVs. The term for turret rotation relative to the carrier is “slewing” hereafter.

### BACKGROUND OF THE INVENTION

A rotating turret vehicle (RTV) typically mounts on the turret, a tool or device that operates more efficiently when carried on a rotating turret. The tool and operator slew together, allowing the operator to easily watch the tool's operation and allows the tool deployment to change without moving the carrier. For example, if the RTV is an excavator, the RTV construction allows the digging bucket to efficiently transfer dirt or other excavated material to a truck. If an army tank is the type of RTV involved, the operator's vision is automatically directed along the turret gun's barrel.

In most cases, hydraulics operate much of the RTV functionality. Hydraulic motors power the wheels or tracks, slew the turret, and operate the tool. In most cases of wheeled RTVs, hydraulics power the steering as well. Tracked RTVs are invariably steered by differential speeds of the tracks, with the track's speed and direction controlled by flow of pressurized hydraulic fluid to two hydraulic motors driving the two tracks.

As already stated, the operator sits in the turret and controls RTV direction of movement with either a combination of a steering wheel, levers, and pedals, or with control levers or pedals only. For example, RTVs with tires may have a steering wheel that controls tire angle, a forward/reverse selector, and an accelerator pedal or lever.

RTVs with tracks typically have one or two levers or pedals assigned to control a single track. For example, moving a left track lever forward causes the left track to propel the left side of the RTV forward. Moving the right track lever forward from a neutral position causes the right track to propel the right side of the RTV forward. Moving the left track lever backwards from the neutral position causes the associated track to move that side of the RTV in reverse.

The distance each lever moves in a particular direction from the neutral position controls the speed of the track in the selected direction.

Pedals that steer a RTV rotate about a transverse axis. Pushing forward on the upper portion of the pedal selects forward movement. Pushing forward on the lower portion of the pedal selects reverse movement.

### SUMMARY OF THE INVENTION

A problem arises in steering a RTV when the turret is slewed more than 90° from directly forward. The sense of the steering is reversed for the operator, so that the operator tends to steer the carrier in the direction opposite that intended. This invention changes the effect of operating a control lever or pedal when the turrets is slewed more than 90° from directly forward.

A RTV of the type having a carrier with a centerline and front and rear ends includes a drive mechanism for moving the carrier along the ground in a forward direction responsive to an actuator signal at a first receptor. As previously explained, a hydraulic motor forms such a receptor and receives pressurized hydraulic fluid forming the actuator signal. The RTV can also move in a reverse direction responsive to an actuator signal at a second receptor.

The RTV has a turret with a centerline and front and rear ends and having an operator station. The turret is mounted on the carrier to allow slewing about a vertical axis. Slewing apparatus provides torque for the slewing function.

The turret has a controller comprising a slew control and a steering control. The slew control is for controlling the slew angle of the turret relative to the carrier. The steering control forming a part of a steering mechanism for providing first and second direction signals to the drive mechanism. Steering includes selecting forward and reverse directions of movement for the RTV and left and right movement when moving forward or reverse.

The invention includes a slew sensor having markers mounted on one of the carrier and the turret. In one version these markers define at least first and second predetermined ranges of the slew angle of the turret centerline relative to the carrier centerline. A sensing unit mounted on the other of the carrier and the turret is positioned to pass within sensing relationship to the markers when the turret slews, and providing a slew signal indicating within which of the at least first and second predetermined ranges of the slew angle the sensing unit is currently positioned.

A steering converter receives the slew signal from the sensing unit. When the slew signal indicates the first predetermined range of the slew angle, the steering converter provides the first direction signal as an actuator signal at the first receptor. When the slew signal indicates the second predetermined range of the slew angles, the converter provides the second direction signal as an actuator signal at the first receptor and the first direction signal as an actuator signal at the second receptor.

In this way, the sense of operation for the steering controls is controlled by the angular position of the turret.

When the turret faces generally forward, the sense is normal. When the turret faces generally to the rear, the sense is reversed, so that the left wheel or tread is controlled by the control nominally assigned to the right wheel or tread, and the right wheel or tread is controlled by the control nominally assigned to the left wheel or tread.

### BRIEF DESCRIPTION OF THE DRAWINGS

FIG. 1 is a top elevation view of a rotating turret vehicle with the turret directed toward the front of the vehicle.

FIG. 1a is a detail of FIG. 1.

FIG. 2 is a top elevation view of a rotating turret vehicle with the turret directed toward the rear of the vehicle.

FIG. 3 is a block diagram of the hydraulic drive system and the control system for the hydraulic drive system

FIG. 4 is a flow chart for software for implementing the control system for the hydraulic drive system.

### DETAILED DESCRIPTION OF THE INVENTION

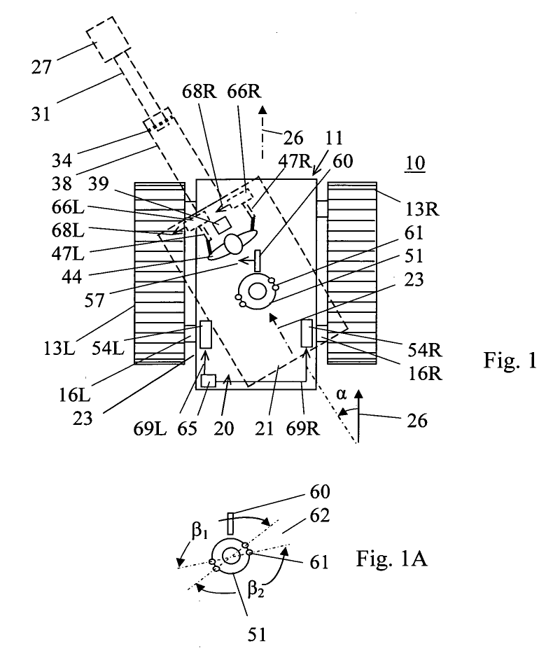

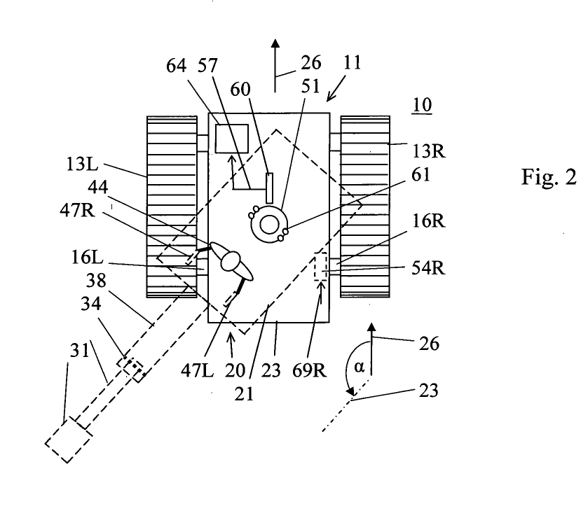

FIG. 1 is a top view of a typical RTV 10. In this and in FIG. 2 dashed lines indicate a turret at 20 and components thereof mounted on an upper surface of a carrier 11. Solid lines in FIGS. 1 and 2 indicate carrier 11 and its components. The reader should be clear that in fact FIGS. 1 and 2 show turret 20 above carrier 11 and therefore closer to the observer even though the carrier elements be low turret 1 and shown in solid lines.

FIG. 1 shows RTV 10 with carrier 11 having left and right tracks 13L and 13R respectively and running on main sprockets (not shown) supported by axles as at 16L and 16R respectively. Hydraulic motors 54L and 54R respectively drive axles 16L and 16R to thereby cause RTV 10 movement across the ground. Motors 54L and 54R receive pressurized hydraulic fluid on paths or receptors 69L and 69R. These pressurized hydraulic fluid flows may be considered as left and right actuator signals respectively. A pump (not shown) provides the pressurized hydraulic fluid flow.

A control system to be described, directs pressurized hydraulic fluid to drive tracks 13L and 13R in both forward and reverse directions and at varying speeds. An operator shown in outline at 44 can control the speed and direction of RTV 10 by differentially varying the speed and direction of tracks 13L and 13R movement.

The body of an arrow 26 defines a centerline of carrier 11 and further, indicates the direction of forward movement of carrier 11. Arrow 26 thusly defines front and back ends of carrier 11, shown at the upper and lower ends of carrier 11 in FIG. 1 respectively.

Turret 20 is mounted on an upper surface of carrier 11. A support 51 allows turret 20 to slew to at least nearly 180° both clockwise and counterclockwise relative to carrier 11. Support 51 may comprise a ring or a stub shaft. An arrow 23 body indicates the centerline of turret 11 and the point indicates the front of turret 11, with the opposite end of turret 11 forming the back end thereof. For convenience, the slew angle of turret centerline 23 relative to carrier centerline 26 is referred to as α. FIGS. 1 and 2 show values for α of approximately −30° and −150° respectively. Values for α clockwise from centerline 26 are positive through 180°. α is negative through −180° counterclockwise from centerline 26. A slew control 39 operates a component that causes turret 11 to slew under operator 44 control.

Turret 20 carries a tool shown as comprising a first arm 38, a second arm 31 rotating with respect to first arm 38 on a pin 34, and a bucket 27. Hydraulic pistons (not shown) control the articulations of arms 31 and 38 and bucket 27 with respect to each other as commonly seen on construction sites.

Turret 20 includes control valves 66L and 66R for controlling the speed and direction of movement of each of the tracks 13L and 13R. Operator 44 sits at an operator station in turret 20 allowing easy access to control levers 47L and 47R that control flow of hydraulic fluid to motors 54L and 54R. The normal convention is that when operator 44 pushes a lever 47L or 47R forward from a neutral position, the associated track 13L or 13R rotates to drive that side of carrier 11 forward. With that convention, when operator 44 pulls a lever 47L or 47R backward from a neutral position, the associated track 13L or 13R rotates to drive that side of carrier 11 backward.

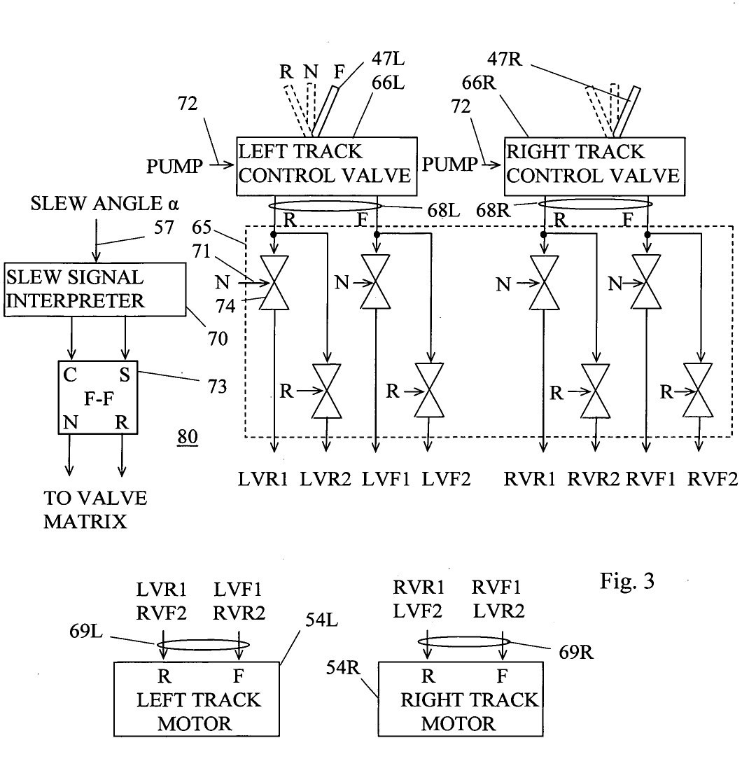

In system 10 of FIG. 1, control valves 66L and 66R may be flow diverter valves providing hydraulic fluid on dual connection output ports 68L and 68R that operate to direct high pressure hydraulic fluid from a supply pump on path 72, see FIG. 3. Each port 68L and 68R comprises a reverse (R) connection and a forward (F) connection for driving the motor 54L and 54R to which it is connected.

Motors 54L and 54R each have a dual connection input port 69L or 69R respectively. Each of the ports 69L and 69R has a reverse (R) connection and a forward (F) connection. When pressurized hydraulic fluid is applied to an R connection, the motor 54L or 54R turns in the reverse direction. When pressurized hydraulic fluid is applied to an F connection, the motor 54L or 54R turns in the forward direction. FIG. 3 shows this diagrammatically.

A slew sensor comprises a series of markers 61 fixed on turret 20 to rotate about support 51, and a sensing unit 60 fixed on carrier 11. As turret 20 rotates, sensing unit 60 provides a slew signal indicating the current angular position of turret 20.

Markers 61 define in some way at least first and second predetermined ranges of α. FIG. 1a shows a first range defined as β1 and extending from the approximate angles of α=−80° to +80°. β2 indicates a second range between α=−110° and α=+110°. Two angular zones 62 are preferably present between the ranges defined by β1 and β2.

The purpose of the invention is to totally reverse the sense of levers 47L and 47R when turret 20 is slewed so that the β2 range is in the sensing range of sensing unit 60. Thus sensing unit 60 provides a first value of a slew signal when turret 20 angular position places a within the β1 range and a second value of a slew signal when turret 20 angular position places α within the β2 range. These signals may comprise two different voltage values, two different voltage polarities, two different positions of a mechanical arm, or any other type of signaling means available to a designer. The

When α falls within zones 62, the slew signal from sensing unit 60 may have a third value different from that for the β1 and β2 ranges.

FIG. 1 shows a hydraulic control unit 65 that provides pressurized hydraulic fluid to motors 54L and 54R according to the slew signal values. When the slew signal value indicates that turret 20 is directed generally toward the front of carrier 11, operation is normal, and lever 47L controls motor 54L in the normal way.

When the slew signal value indicates that turret 20 is directed generally toward the rear of carrier 11, operation is reversed, and lever 47L controls motor 54R in the opposite or reverse way. That is, when in reversed operation mode, pushing lever 47L forward causes motor 54R to run in reverse, and pushing lever 47R forward causes motor 54L to run in reverse. This operation recreates the customary operation of levers 47L and 47R when turret 11 is facing forward. A valve matrix 65 under control of a steering converter 80 shown in FIG. 3 changes the connections to provide the reversed control sense functionality.

FIG. 3 shows a steering converter 80 as comprising a slew signal interpreter 70 that receives the slew signal from sensing unit 60. Interpreter 70 can take a large number of forms; that shown here is electronic, preferably implemented using a microprocessor for example. Indeed, a microprocessor forming interpreter 70 may implement portions of sensing unit 60 as well.

Regardless of the design of interpreter 70, a flip-flop 73 serves as a source for the signals controlling operation of valve matrix 65. Flip-flop 73 has a clear (C) input, a set (S) input, a normal (N) output, and a reverse (R) output. Each input has either a logical 0 or a logical 1 value. Each output similarly has either a logical 0 or logical 1 value. These logical values are typically different voltage levels. For purposes of this description, a logical 0 will be considered to be 0 v. and logical 1 will be considered to be +5 v.

A logical 1 on the C input sets the N output to a logical 1 (5 v.) and the R output to a logical 0 (0 v.). A logical 1 on the S input sets the R output to a logical 1 (5 v.) and the N output to a logical 0 (0 v.). This is standard operation for a set-clear type of flip-flop and well known to those with even modest skill in the art.

Matrix 65 comprises eight substantially identical individual valves. Each valve receives pressurized hydraulic fluid from one or the other of control valves 66L and 66R. The matrix 65 valves are electrically controlled by the output of flip-flop 73. A logical 1 applied to a valve 74 control terminal 71 opens the valve. A logical 0 applied to a valve control terminal 71 closes the valve. Each of the valves in matrix 65 receives a control signal from either the N or R output of flip-flop 73 as indicated in FIG. 3.

Manually operated track control valves 66L and 66R are diverter valves that direct pressurized hydraulic fluid on connection 72 to either the R or F output connection. When an operator 44 pushes control lever 47L for example forward into the F position shown, hydraulic fluid flows through the F connection as a first direction signal. When operator 44 pulls control lever 47L backwards into the R position shown, hydraulic fluid flows through the R connection and forms a second direction signal. When operator 44 places lever 47L in the neutral (N) position, fluid flows to neither connection. Speed control may be incorporated in valves 54L and 54R or may be provided by flow control valves not shown.

Each valve of matrix 65 has a designated output port that is connected to one only of the two (R and F) input ports of either the left track motor 54L or the right track motor 54R.

Each valve output has a code designating the output. Each motor 54L and 54R has an input with two codes that indicate the hydraulic hose connections between the valves of valve matrix 65 and the motors 54L and 54R.

The design of matrix 65 directs the pressurized hydraulic fluid as the actuator signal to the proper input port of a motor 54L and 54R depending on the setting of flip-flop 73. Low pressure hydraulic fluid that exits motors 54L and 54R returns to a storage tank

Of course, other embodiments may be possible for controlling motors 54L and 54R.

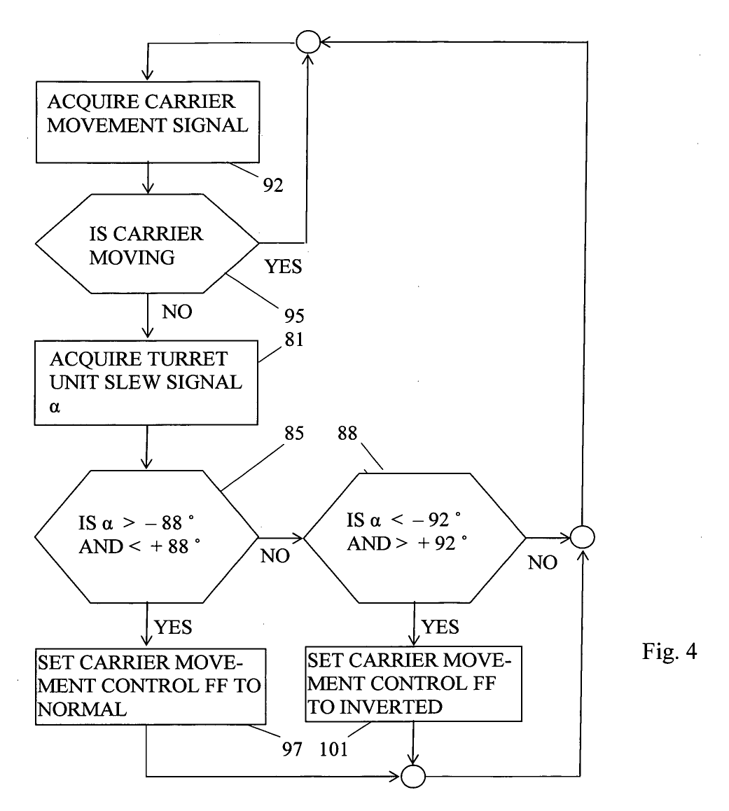

FIG. 4 shows a flow chart for one possible implementation of the interpreter 70 logic. This flow chart represents software operating in a continuous loop starting with element 92. Each of the elements is either a decision element as at 85 or a activity element as at 92. Microprocessor instructions implement each element. These instructions are recorded in a physical memory and executed by a physical microprocessor. Thus, the actual elements have physical existence and are in no way mental steps.

Activity element 92 receives a signal perhaps provided by the position of levers 47L or 47R, that indicates carrier 95 is moving. Since changing control sense for levers 47L and 47R while carrier 11 is moving might confuse the operator, this limitation is shown here. This is an optional feature though, and perhaps might be under operator control instead.

Decision element 95 returns processing to activity element if carrier 11 is moving.

Activity element 81 acquires the slew signal from sensing unit 60. In this software embodiment, the slew signal is the angle α. Decision element 85 tests whether α satisfies −88°<α<+88°. If so, activity element 97 clears flip-flop 73. If not, then the instructions for decision element 88 test whether α satisfies −92°>α>+92°. If so then activity element 101 sets flip-flop 73. In this way, software or firmware in a microprocessor can control operation of valve matrix 65 and the actions of motors 54L and 54R in response to movement of levers 47L and 47R.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. In a RTV of the type having a carrier with a centerline and front and rear ends, and including a drive mechanism for moving the carrier along the ground in a forward direction responsive to an actuator signal at a first receptor, in a reverse direction responsive to an actuator signal at a second receptor; and a turret with a centerline and front and rear ends and having an operator station, said turret mounted on said carrier to allow slewing about a vertical axis, and in which turret a controller comprising a slew control and a steering control is located, said slew control for controlling the slew angle of the turret relative to the carrier and said steering control forming a part of a steering mechanism for providing first and second direction signals to the drive mechanism, wherein the invention comprises:
a) a slew sensor having markers mounted on one of the carrier and the turret defining at least first and second predetermined ranges of the slew angle of the turret centerline relative to the carrier centerline, and a sensing unit mounted on the other of the carrier and the turret and positioned to pass within sensing relationship to the markers when the turret slews, and providing a slew signal indicating within which of the at least first and second predetermined ranges of the slew angle the sensing unit is currently positioned; and
b) a steering converter receiving first and second direction signals and the slew signal for, responsive to the slew signal indicating the first predetermined range of the slew angle, providing the first direction signal as an actuator signal at the first receptor and responsive to the slew signal indicating the second predetermined range of the slew angles providing the second direction signal as an actuator signal at the first receptor and the first direction signal as an actuator signal at the second receptor.

2. The RTV of claim 1, wherein the slew sensor provides slew signals indicating first and second predetermined ranges of the slew angle that are non-overlapping.

3. The RTV of claim 2, wherein the markers are spaced to cause the sensing unit to provide a slew signal value indicating one or the other of first and second predetermined ranges of the slew angle that are angularly spaced from each other, and a third slew signal value indicating a slew angle between the first and second predetermined slew angle ranges, and wherein the converter, when the slew signal falls outside both the first and second predetermined ranges, includes state control means leaving the current state of direction and actuator signals unchanged.

4. The RTV of claim 3, wherein the state control means includes a flip-flop, and wherein the flip-flop sets to first and second states respectively providing a normal and a reversed signal output responsive to respectively, the slew signal indicating one or the other of first and second predetermined ranges of the slew angle, and wherein the state control means leaves the flip-flop state unchanged responsive to the slew signal indicating other than the first and second predetermined ranges of the slew angle.
